(19) United States
(12) Patent Application Publication
(10) Pub. No.: US 2026/0158530 A1
(43) Pub. Date: Jun. 11, 2026

(54) TANK CLEANER AND METHOD OF ASSEMBLY

(71) Applicant: GEA Tuchenhagen GmbH, Buchen (DE)

(72) Inventor: Richard Collins, Cradley (GB)

(21) Appl. No.: 19/386,624

(22) Filed: Nov. 12, 2025

(30) Foreign Application Priority Data
Dec. 5, 2024 (DE) 102024136264.2
Dec. 9, 2024 (DE) 102024136751.2

(51) Int. Cl. B08B 9/093; B05B 15/60; B05B 13/06

(52) U.S. Cl. CPC B08B 9/0936; B05B 15/60; B05B 13/0636; B05B 13/069

(57) ABSTRACT

A tank cleaner comprising a static body for coupling with a supply line for receiving a cleaning fluid, a rotating body mounted on the static body, a gear assembly partly arranged in the static body having a main input shaft and a main output shaft for driving the rotating body, and a nozzle carrier mounted to the rotating body and having a sub output shaft being driven by the main output shaft, and at least one nozzle for dispensing the cleaning fluid. The invention suggests that the main output shaft has a distal end extending beyond the sub output shaft along a main axis of rotation about which the rotating body is rotary mounted. The invention further relates to a method for mounting a tank cleaner.

### CROSS-REFERENCE TO RELATED APPLICATIONS

This application claims priority to German Patent Application Nos. 102024136264.2, filed on December 5, 2024, and 102024136751.2, filed on December 9, 2024, the entire disclosures of which are incorporated by reference in their entirety.

### FIELD

The present invention relates to a tank cleaner, in particular orbital cleaner, for cleaning a tank. The tank cleaner comprises a static body having a housing with an upper housing part configured for coupling with a supply line for receiving a cleaning fluid and a lower housing part, a rotating body rotary about a main axis of rotation mounted on the static body, a gear assembly comprising a gear assembly with a main input shaft and a main output shaft extending beyond the housing and being configured to drive the rotating body around the main axis of rotation, and a nozzle carrier rotary about a sub-axis of rotation mounted to the rotating body, the nozzle carrier having a sub output shaft extending in the direction of the sub-axis of rotation and being driven by the main output shaft, and at least one nozzle for dispensing the cleaning fluid, the sub-axis of rotation being different from the main axis of rotation.

### BACKGROUND

In the field of tank cleaning, particularly in industrial and commercial settings, it is common to employ tank cleaners that utilize rotating nozzles to deliver high-pressure cleaning fluids. These devices are essential for maintaining hygiene and operational efficiency in tanks used for storing various substances, including food products, chemicals, and pharmaceuticals. Known systems typically involve a combination of static and rotating components, driven by fluid pressure, to achieve the desired cleaning effect. The rotating nozzles are generally powered by a gear arrangement that translates the fluid pressure into rotational motion.

According to known approaches, tank cleaners usually consist of a static body connected to a supply line for receiving the cleaning fluid and a rotating body that houses the nozzles. DE 10 2019 005 830 A1 shows such a tank cleaner. The rotating body is driven by a gear assembly, which converts the fluid pressure into rotational motion. However, these systems often suffer from issues such as complex assembly and disassembly processes, which can lead to increased downtime and maintenance costs. During assembly, unwanted loads, such as torques, act on the components. This is particularly challenging for threaded connections. Additionally, the alignment and engagement of various components within the gear assembly can be challenging, resulting in suboptimal performance and potential mechanical failures, e.g. due to high water pressure and pressure drops. The need for precise alignment and secure engagement of the rotating and static parts is critical to ensure consistent and effective cleaning.

Despite the substantial advances in the field of tank cleaning technology, there remains a need for improvements that address these challenges. Existing systems may not provide the desired resistance against pressure drops within the rotating body. Furthermore, the complexity of current designs can lead to increased operational costs and reduced efficiency, highlighting the necessity for a more robust and user-friendly solution.

It is therefore a technical problem underlying the present invention to provide a tank cleaner that at least partially overcomes the disadvantages of known systems.

### SUMMARY

It is an object of this invention to provide a tank cleaner that overcomes one or more of the disadvantages of known systems.

According to first aspect of the invention, these objects are addressed by a tank cleaner according to claim 1.

The tank cleaner comprises a static body configured for coupling with a supply line to receive a cleaning fluid, ensuring a steady and controlled flow of the cleaning medium. The rotating body, mounted on the static body, rotates about a main axis of rotation, driven by a gear assembly housed at least partly within the static body. This gear assembly includes a main input shaft and a main output shaft, both extending in the direction of the main axis of rotation. The main output shaft drives the rotating body, facilitating a consistent and powerful rotation essential for effective cleaning. A nozzle carrier, mounted to the rotating body, rotates about a sub-axis of rotation, which is distinct from the main axis of rotation. This nozzle carrier includes a sub output shaft, driven by the main output shaft, and is equipped with at least one nozzle for dispensing the cleaning fluid. The differentiation between the main and sub axes of rotation allows for a more comprehensive coverage of the tank's interior surfaces, addressing the challenge of reaching all areas within the tank.

The invention solves the initially mentioned object by suggesting that the main output shaft has a distal end that extends beyond the sub output shaft along the main axis of rotation. This specific arrangement may help in better withstanding pressure drops within the rotating body by reducing the internal twisting forces and supports the force distribution along the main output shaft which extends longer than state of the art output shafts. Moreover, the nozzle carrier’s sub output shaft extends through the rotating body which may enable a well-balanced bearing of the nozzle carrier. In particular, the sub output shaft extends almost completely—and thus over at least 75% of the extension in the direction of the sub-axis of rotation—through the rotating body. In particular, the sub output shaft extends completely through the rotating body. Both, the extension of the sub output shaft and the extension of the main output shaft, may be beneficial during assembly of the tank cleaner as it improves alignment of the shafts and provides more design freedom for the bearing. Further, the design freedom with regard to possible coupling mechanisms is increased by suggesting that the main output shaft extends beyond the sub output shaft. The technical configuration of the gear assembly and the relative positioning of the shafts may provide a more efficient transfer of rotational force, reduced twisting forces, enhancing the overall performance and reliability of the tank cleaner.

Further embodiments of the invention are given in the dependent claims, which further develop the concept of the invention with regard to advantageous features in the context of the object of the invention and with regard to further advantages.

According to a second aspect which is also a preferred embodiment of the first aspect, the initially mentioned object is solved by a tank cleaner according to claim 2. The Invention solves the initially mentioned object according to the second aspect in that the main output shaft, particularly the distal end of the main output shaft, is in form-fit engagement with the rotating body. Thereby a transmission of rotational motion from the gear assembly to the rotating body may be provided, in particular a secure and precise transmission. The form-fit engagement implies that the distal end of the main output shaft is designed to interlock or mesh with a corresponding structure on the rotating body, thereby preventing any relative movement between these components during operation. This engagement can be achieved through various mechanical configurations such as splines, keys, or other interlocking geometries that provide a positive connection. The introduction of this feature brings several advantages to the tank cleaner. Firstly, it enhances the structural integrity and reliability of the rotational drive mechanism, ensuring that the rotating body is driven consistently and accurately by the main output shaft. This is particularly important in maintaining the efficiency and effectiveness of the cleaning process, as any slippage or misalignment could result in suboptimal cleaning performance. Secondly, the form-fit engagement reduces wear and tear on the components, as the positive connection minimizes the relative motion that can lead to abrasion and degradation over time. This contributes to the longevity and durability of the tank cleaner, reducing maintenance requirements and downtime. Additionally, state of the art tank cleaner secure the upper static body with the lower rotating body with a threaded connection and then secure the tank cleaner by a secondary method. Thus, the assembly is simplified by suggesting a form-fit engagement, as the form-fit engagement provides a straightforward and reliable means of connecting the main output shaft to the rotating body. The form-fit engagement substitutes the threaded connection and preferably also the secondary method. In particular, the secondary method may also be realized by a form-fit connection. Thus, the form-fit engagement allows coupling of the output shaft with the rotating body without any torque acting on the components during assembly. This is a particular benefit when compared to a thread engagement. Further, a form-fit engagement allows decreasing the time for assembly compared to a thread engagement. Furthermore, the precise alignment provided by the form-fit engagement can enhance the overall balance and stability of the rotating body, reducing vibrations and noise during operation. This not only improves the user experience but also minimizes the risk of damage to the tank or the cleaner itself.

According to a further embodiment, the main output shaft is in engagement, particularly in form-fit engagement, with the sub output shaft. This engagement mechanism is enabled by the main output shaft extending beyond the sub output shaft and signifies a direct and precise interaction between the main output shaft and the sub output shaft, ensuring a reliable transfer of rotational motion from the main axis of rotation to the sub-axis of rotation. The form-fit engagement indicates that the components are designed to interlock in a specific manner, potentially through complementary shapes such as splines, gears, or other interlocking structures, which may prevent slippage and may provide synchronized movement. This precise engagement mechanism enhances the operational efficiency of the tank cleaner by maintaining consistent and controlled rotation of the nozzle carrier, which may be beneficial for effective cleaning. The form-fit engagement also implies a robust mechanical connection that can withstand the operational stresses and forces encountered during the cleaning process, thereby improving the durability and longevity of the device. Furthermore, this engagement mechanism facilitates the accurate alignment of the sub output shaft with the main output shaft, ensuring that the nozzle carrier rotates smoothly and uniformly about the sub-axis of rotation. This uniform rotation is essential for the even distribution of the cleaning fluid, which is dispensed through the nozzles, thereby optimizing the cleaning performance. Additionally, the form-fit engagement mechanism simplifies the assembly and maintenance of the tank cleaner, as the interlocking components can be easily aligned and secured.

According to a further embodiment, the sub output shaft is in engagement with the nozzle carrier and a gear body of the gear assembly. The engagement mechanism between the sub output shaft and the nozzle carrier likely involves a mechanical coupling, such as a keyed connection or splines, which may provide that the rotational motion is effectively transferred without slippage. This engagement allows a direct toque transmission from the gear body of the gear assembly to the nozzle carrier via the sub output shaft connecting both. The gear body is mounted to the rotating body and is in engagement with the main output shaft for converting the torque of the main output shaft into a rotation of the sub output shaft. This conversion mechanism may be beneficial for the proper functioning of the tank cleaner, as it may provide that the rotational motion generated by the main output shaft is effectively transferred to the sub output shaft, thereby driving the nozzle carrier. Further, this engagement enables reduction of additional bearings and complex coupling mechanisms. The new features introduced by this embodiment bring several advantages to the tank cleaner. Firstly, the engagement of the sub output shaft with both the nozzle carrier and the gear body may provide a direct and efficient transmission of rotational motion, reducing potential losses and enhancing the overall performance of the cleaning process. Secondly, the mounting of the gear body to the rotating body may provide that the gear assembly remains stable and aligned, reducing wear and tear on the components and extending the operational lifespan of the tank cleaner. Finally, the conversion of torque from the main output shaft to the sub output shaft via the gear body allows for precise control of the rotational speeds and torques, enabling the nozzle carrier to operate effectively under various cleaning conditions. These features collectively enhance the functionality, reliability, and efficiency of the tank cleaner, making it a more effective tool for cleaning tanks. The sub output shaft preferably extends all the way through the nozzle carrier.

According to a further embodiment, the sub output shaft that is supported on the rotating body by direct engagement with both the nozzle carrier and the gear body. The direct engagement implies that the sub output shaft is mechanically connected to the nozzle carrier and the gear body without intermediary components, which can reduce mechanical complexity and potential points of failure.

According to a further embodiment, the rotating body has a support structure for holding the main output shaft in a locking position. This support structure serves as a beneficial intermediary component that may maintain that the main output shaft remains securely in place during assembly and operation of the tank cleaner. The presence of this support structure mitigates the risk of misalignment or displacement of the main output shaft, which could otherwise lead to operational inefficiencies or mechanical failures. Furthermore, the main output shaft is form-fit locked in the locking position by a locking element. This form-fit locking mechanism involves a precise interlocking of components, ensuring that the main output shaft is securely held in the designated position without any possibility of unintended movement. The locking element is specifically designed to engage with the main output shaft in a manner that prevents axial or rotational displacement, thereby maintaining the correct alignment and orientation of the shaft relative to the main axis of rotation. This form-fit locking mechanism provides an additional layer of security and stability, ensuring that the main output shaft remains in the optimal position for driving the rotating body and the nozzle carrier. Additionally, these features facilitate easier maintenance and servicing of the tank cleaner, as the secure locking of the main output shaft simplifies the disassembly and reassembly processes.

According to a further embodiment, the sub output shaft extends through the support structure. Thus, the sub output shaft is securely anchored and properly aligned within the tank cleaner's overall assembly. By extending through the support structure, the sub output shaft gains additional stability and support, which may be beneficial for maintaining the precise rotational movement necessary for effective cleaning. This structural integration helps to minimize wobbling or misalignment that could otherwise occur during the operation of the tank cleaner, thereby enhancing the reliability and efficiency of the cleaning process. Furthermore, the extension of the sub output shaft through the support structure facilitates a more robust connection between the rotating body and the nozzle carrier, ensuring that the transmission of rotational force from the main output shaft to the sub output shaft is smooth and consistent. The support structure itself acts as a stabilizing element, providing a firm foundation for the sub output shaft and helping to distribute the mechanical loads generated during operation. Additionally, the integration of the sub output shaft with the support structure can simplify the assembly and maintenance of the tank cleaner, as it provides a clear and straightforward path for the sub output shaft, reducing the complexity of the internal configuration.

According to a further embodiment, the support structure includes at least one guide passageway opening configured to guide the sub output shaft there through. Thus, the sub output shaft is precisely aligned and maintained in its intended path of rotation about the sub-axis of rotation. The guide passageway opening serves as a conduit through which the sub output shaft extends, providing a controlled and stable bearing for its movement. By guiding the sub output shaft through the guide passageway, the support structure effectively minimizes any lateral or axial deviations that could occur during the rotation, thereby enhancing the accuracy and consistency of the nozzle carrier's rotational movement. This precise guidance mechanism may be beneficial for the optimal performance of the nozzle carrier, which is responsible for dispensing the cleaning fluid.

According to a further embodiment, the main output shaft has a guide recess corresponding to the guide passageway opening and configured to guide the sub output shaft there through. The guide recess serves as a channel or pathway that facilitates the movement and alignment of the sub output shaft as it extends through the main output shaft. This configuration may provide that the sub output shaft is precisely guided and maintained in its intended position relative to the main output shaft, thereby enhancing the stability and accuracy of the rotational movements of the nozzle carrier. The introduction of the guide recess and the corresponding guide passageway opening brings several advantages to the tank cleaner. Firstly, it improves the mechanical integrity and alignment of the rotating components, reducing the likelihood of misalignment or mechanical failure during operation. Secondly, the guide recess and guide passageway opening facilitate smoother and more controlled rotational movements of the nozzle carrier. Additionally, the incorporation of the guide recess and guide passageway opening can contribute to the durability and longevity of the tank cleaner by minimizing wear and tear on the rotating components. By providing a guided pathway for the sub output shaft, the system can reduce friction and mechanical stress on the shaft and associated components, thereby extending their operational lifespan. This can result in lower maintenance requirements and reduced downtime for the tank cleaner, further enhancing its cost-effectiveness and reliability in industrial cleaning applications.

According to a further embodiment, the support structure has at least one locking passageway opening configured to receive the locking element in the locking position. The locking passageway opening is designed to accommodate the locking element, ensuring that when the locking element is in the locking position, it effectively secures the rotating body and the nozzle carrier, preventing unintended movement or disassembly. This configuration is particularly beneficial in maintaining the precise alignment and rotational integrity of the nozzle carrier and the rotating body, which may be beneficial for the efficient and thorough cleaning of the tank. By incorporating this locking mechanism, the tank cleaner may provide that the gear assembly and the rotating components remain firmly in place, even under the high-pressure conditions typically encountered during cleaning operations. This added stability not only improves the reliability and durability of the tank cleaner but also enhances the safety of its operation by reducing the risk of mechanical failure or accidental disassembly. Furthermore, the locking passageway opening provides a straightforward and effective means for maintenance and assembly, allowing for quick and secure locking and unlocking of the components. This feature simplifies the process of servicing the tank cleaner, making it easier to perform routine maintenance or replace parts without compromising the overall integrity of the device.

According to a further embodiment, the main output shaft has a locking recess corresponding to the locking passageway opening and configured to receive the locking element in the locking position. The locking recess on the main output shaft is precisely aligned with the locking passageway opening, ensuring that the locking element can be securely received and retained in the locking position. This configuration allows for a more reliable and robust connection between the rotating body and the static body, preventing unintended disassembly or misalignment during operation. The locking element, when engaged in the locking recess, effectively immobilizes the main output shaft relative to the static body, thereby maintaining the desired orientation and rotational dynamics of the rotating body and the nozzle carrier. This feature is particularly advantageous in high-pressure cleaning applications where the stability and precision of the rotating components may be beneficial for achieving optimal cleaning performance. By incorporating a locking recess on the main output shaft, the design may provide that the rotational forces and vibrations generated during the cleaning process do not compromise the structural integrity of the tank cleaner. Furthermore, this locking mechanism simplifies the assembly and maintenance of the tank cleaner, as it provides a straightforward and secure method for aligning and securing the main output shaft within the static body. Additionally, the locking recess and corresponding passageway opening are designed to accommodate various types of locking elements, such as pins, bolts, or other fasteners, providing flexibility in the choice of locking mechanisms based on specific application requirements.

According to a further embodiment, the tank cleaner, particularly the orbital cleaner, includes a fastening element configured to fasten the locking element in the locking position. The fastening element serves as a securing component that may provide that the locking element remains in a fixed position when engaged, thereby preventing any unintended movement or disengagement during the cleaning operation. By incorporating a fastening element, the tank cleaner benefits from an added layer of security, which is essential for operations in environments where vibrations or fluid dynamics could potentially cause components to shift. The fastening element could be designed in various forms, such as a ring, belt, clamp, bolt, or latch, each providing a robust solution to secure the locking element effectively. This feature not only enhances the mechanical integrity of the tank cleaner but also contributes to its operational safety. Moreover, this feature simplifies maintenance and inspection procedures, as operators can easily verify the locked position of the components, ensuring that the cleaner is always in optimal working condition.

According to a further embodiment, the main output shaft is aligned by the locking element in the locking position so that the nozzle carrier’s sub output shaft can be passed through the guide passageway opening. This alignment mechanism introduces a precise and reliable means of ensuring that the main output shaft and the nozzle carrier’s sub output shaft are correctly positioned relative to each other, thereby facilitating the smooth operation of the nozzle carrier. The locking element serves as a beneficial intermediary that may provide the main output shaft is held in the correct orientation, preventing any misalignment that could disrupt the rotational dynamics of the nozzle carrier. The guide passageway opening acts as a conduit through which the nozzle carrier’s sub output shaft can be accurately positioned, further contributing to the overall precision of the tank cleaner's operation. This arrangement not only simplifies the assembly and maintenance of the tank cleaner but also enhances its operational reliability by reducing the likelihood of mechanical failures due to misalignment.

According to a further embodiment, the guide passageway opening and the locking passageway opening are aligned in parallel and arranged at a distance in the direction of the main rotation axis. This feature also simplifies the assembly and maintenance processes, as the parallel and spaced arrangement of the openings provides clear reference points for the installation and alignment of the components. Further, the accessibility is improved by arranging the guide passageway opening and the locking passageway opening in parallel and by arranging both at a distance, they do not disturb each other.

According to a further embodiment, the locking recess and/or the guide recess are provided at the distal end of the main output shaft. The locking recess and/or guide recess at the distal end of the main output shaft serves as a precise engagement point, ensuring secure and stable coupling with corresponding components, thereby preventing unintended disassembly or misalignment during operation. Further, the arrangement of the locking recess and/or guide recess at the distal end of the main output shaft aids to better withstand pressure drops during operation due to better force transmission. The presence of these recesses at the distal end of the main output shaft also allows for easier assembly and maintenance of the tank cleaner, as they provide clear reference points for the alignment and positioning of the components.

The invention solves the initially mentioned object in a third aspect by a gear assembly according to claim 16. The gear assembly is specifically designed for the tank cleaner, in particular for a tank cleaner according to the first or second aspect, and includes a main input shaft that in particular serves as the primary conduit for transmitting mechanical energy from a supply line to the internal components of the cleaner. The main output shaft extends in the direction of the main axis of rotation, ensuring that the rotational energy is effectively transferred to the rotating body, thereby enabling it to rotate around the main axis of rotation. Additionally, the main output shaft is configured to drive a sub output shaft, which extends in the direction of a sub-axis of rotation. This sub-axis of rotation is distinct from the main axis of rotation, introducing a secondary rotational movement that enhances the cleaning coverage and effectiveness of the tank cleaner. The sub output shaft is responsible for driving the nozzle carrier, which houses at least one nozzle for dispensing the cleaning fluid. This dual-axis rotation mechanism may provide that the cleaning fluid is dispensed in a comprehensive and controlled manner, reaching all areas within the tank. Furthermore, the main output shaft features a distal end that extends preferably beyond the sub output shaft along the main axis of rotation or the main output shaft, particularly the distal end of the main output shaft, is in form-fit engagement with the rotating body allowing transmission of rotational motion from the gear assembly to the rotating body. By incorporating these features, the gear assembly participates from the advantages described with regard to the first and second aspect of the invention. Thus, benefits and preferred embodiments of the first and second aspect of the invention are at the same time benefits and preferred embodiments of the third aspect of the invention.

The invention solves the initially mentioned object in a fourth aspect by a method for mounting a tank cleaner according to claim 17. The method for mounting a tank cleaner begins with coupling a static body with a supply line for receiving a cleaning fluid, thereby in particular establishing a foundational connection that may enable a continuous and controlled flow of cleaning fluid into the system. Following this, a rotating body is mounted on the static body, allowing it to rotate about a main axis of rotation. This rotational capability may be beneficial for the dynamic operation of the tank cleaner, enabling it to reach various areas within the tank. Subsequently, a nozzle carrier is mounted to the rotating body, allowing it to rotate about a sub-axis of rotation, which is distinct from the main axis. This dual-axis rotation enhances the cleaning coverage and flexibility of the tank cleaner, allowing it to target specific areas more effectively. The nozzle carrier is designed with a sub output shaft that extends through the rotating body in the direction of the sub-axis of rotation, facilitating the precise delivery of cleaning fluid through the nozzles. The gear assembly is then arranged such that its main output shaft extends from the static body into the rotating body in the direction of the main axis of rotation. This configuration may provide that the rotating body is driven around the main axis of rotation, providing the necessary mechanical power for its operation. Additionally, according to a first preferred design, the main output shaft features a distal end that extends along the main axis of rotation within the rotating body, beyond the sub output shaft. Alternatively or additionally, the main output shaft, particularly the distal end of the main output shaft, is in form-fit engagement with the rotating body. By incorporating these features, the method participates from the advantages described with regard to the first aspect of the invention. Thus, benefits and preferred embodiments of the first and second aspect of the invention are at the same time benefits and preferred embodiments of the fourth aspect of the invention.

According to a further embodiment of the method, the main output shaft, including its distal end, is brought into form-fit engagement with the rotating body, ensuring a secure and precise connection that facilitates the effective transmission of rotational force. This engagement mechanism may be beneficial for maintaining the alignment and stability of the rotating body during operation.

According to a further embodiment of the method, the main output shaft is brought into engagement, particularly in form-fit engagement, with the sub output shaft. This is essential for the coordinated rotation of the nozzle carrier about its sub-axis of rotation. This engagement may provide that the rotational motion from the main output shaft is accurately transferred to the sub output shaft, enabling the nozzle carrier to dispense the cleaning fluid effectively.

According to a another embodiment of the method, the main output shaft is held in a locking position by a support structure of the rotating body and is locked form-fittingly in this position by a locking element. This locking mechanism provides additional stability and prevents any unintended movement or dislodgement of the main output shaft during operation, thereby enhancing the reliability of the tank cleaner.

According to a further embodiment of the method, the sub output shaft is guided through at least one guide passageway opening of the support structure. Thereby it may be provided that the sub output shaft remains properly aligned and can rotate smoothly. This guiding mechanism is preferably complemented by guiding the sub output shaft through a guide recess corresponding to the guide passageway opening of the main output shaft. This may further provide precise alignment and smooth operation.

According to a further embodiment of the method, the sub output shaft is guided through at least one locking passageway opening of the support structure, and through a locking recess corresponding to the locking passageway opening of the main output shaft. These guiding mechanisms collectively may provide that the sub output shaft is securely positioned and can rotate without obstruction.

Finally, the locking element is preferably fastened in the locking position by a fastening element, which provides an additional layer of security and may provide that the locking mechanism remains engaged during the operation of the tank cleaner. These features collectively enhance the structural integrity, operational reliability, and overall performance of the tank cleaner, making it more effective in its intended application of cleaning tanks.

### BRIEF DESCRIPTION OF THE DRAWINGS

The present disclosure will be explained in more detail, by way of example, with reference to the drawings in which:

FIG. 1a: shows an embodiment of a tank cleaner with a static body, rotating body, nozzle carrier, and nozzles;

FIG. 1b: shows a cross-sectional view of the tank cleaner, illustrating the internal components including the supply line, gear assembly, main input shaft, main output shaft, sub output shaft, and locking position;

FIG. 2: shows a first perspective exploded view of a tank cleaner with various components including a static body, rotating body, gear assembly, nozzle carrier, and associated shafts and elements;

FIG. 3: shows a second perspective exploded view of an embodiment of a tank cleaner, illustrating the static body, rotating body, gear assembly, nozzle carrier, and various shafts and components; and

FIG. 4: shows a flow-chart illustrating a method for mounting a tank cleaner.

### DETAILED DESCRIPTION

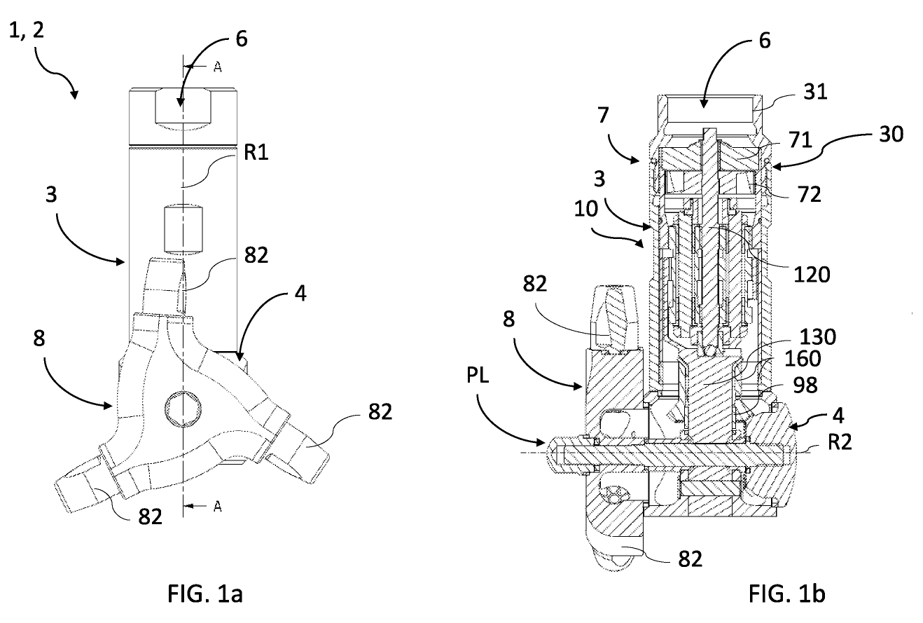

FIG. 1a illustrates a tank cleaner 1, specifically an orbital cleaner 2, designed for cleaning a tank.

The tank cleaner 1 comprises a static body 3, a rotating body 4 and a nozzle carrier 8. The static body 3 includes a housing 30 with an upper housing part 31 and a lower housing part 32. The upper housing part 31 is configured for coupling with a supply line 6 to receive cleaning fluid. The upper housing part 31 facilitates the connection to the supply line 6, ensuring the cleaning fluid is directed into the housing 30 for subsequent use in the cleaning process.

The rotating body 4 is mounted on the static body 3 and rotates about a main axis of rotation R1.The rotating body 4 is driven by a gear arrangement 10 (see FIG. 1b) and a driving arrangement 7 (see FIG. 1b) around the main axis of rotation R1. This rotational capability allows the rotating body 4 to perform cleaning operations within the tank by distributing the cleaning fluid in a controlled manner. The rotating body 4, which is mounted on the static body 3, rotates about the main axis of rotation R1, wherein the nozzle carrier 8 is supported by the rotating body 4 rotary around a sub- axis of rotation R2.

The driving arrangement 7 includes a stator 71 and an impeller 72, which are housed within an enclosure part 94.

The gear assembly 10, partially housed within the static body 3, includes a main input shaft 120 and a main output shaft 130, both extending along the main axis of rotation R1. The main output shaft 130 drives the rotating body 4 around the main axis of rotation R1.

The nozzle carrier 8, which rotates about a sub-axis of rotation R2, is mounted on the rotating body 4. The nozzle carrier 8 includes a sub output shaft 81 extending along the sub-axis of rotation R2 and driven by the main output shaft 130. The nozzle carrier 8 is equipped with at least one nozzle 82 for dispensing the cleaning fluid. The sub-axis of rotation R2 is distinct from the main axis of rotation R1.

FIG. 1b provides a sectional view of the tank cleaner 1, detailing the internal components and their arrangement. The static body 3 is coupled to the supply line 6, which directs the cleaning fluid into the static body 3.

The driving arrangement 7 is coupled to the main input shaft 120 and is responsible for driving the main input shaft 120 using the force provided by the received cleaning fluid. This coupling allows the cleaning fluid to power the gear assembly 10, which in turn drives the rotating body 4.

The gear assembly 10, located within the static body 3, comprises the main input shaft 120 and the main output shaft 130. The main output shaft 130 extends beyond the sub output shaft 81 along the main axis of rotation R1, as indicated by the distal end 132.

The rotating body 4 is mounted on the static body 3 and is driven by the main output shaft 130. The nozzle carrier 8, mounted on the rotating body 4, rotates about the sub-axis of rotation R2. The gear assembly 10 includes a gear body 160, which is mounted on the rotating body 4 and engages with the main output shaft 130. The gear body 160 is preferably supported on the main 0utput shaft 130 by a main output shaft bearing 98. This engagement converts the torque from the main output shaft 130 into the rotation of the sub output shaft 81. The sub output shaft 81 is supported on the rotating body 4 through direct engagement with both the nozzle carrier 8 and the gear body 160.

The sub output shaft 81, extending through the rotating body 4, is driven by the main output shaft 130. The nozzle carrier 8 is equipped with multiple nozzles 82, which dispense the cleaning fluid during operation.

The sectional view in FIG. 1b clearly demonstrates the alignment and engagement of the various components, ensuring the efficient operation of the tank cleaner 1

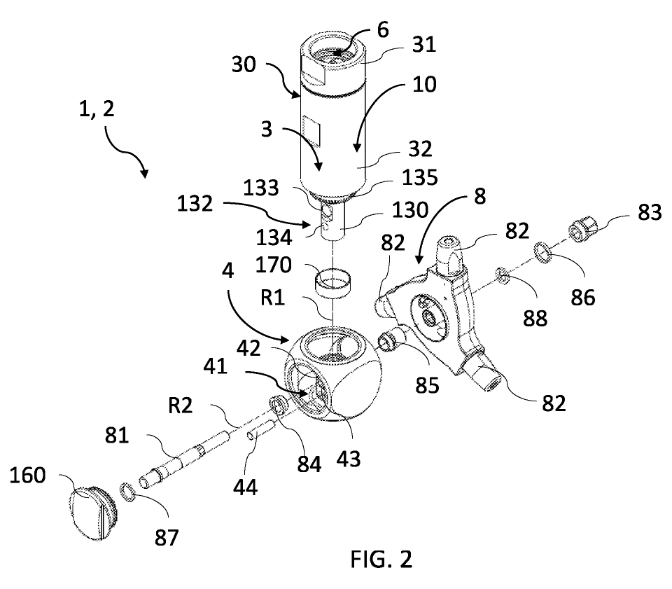

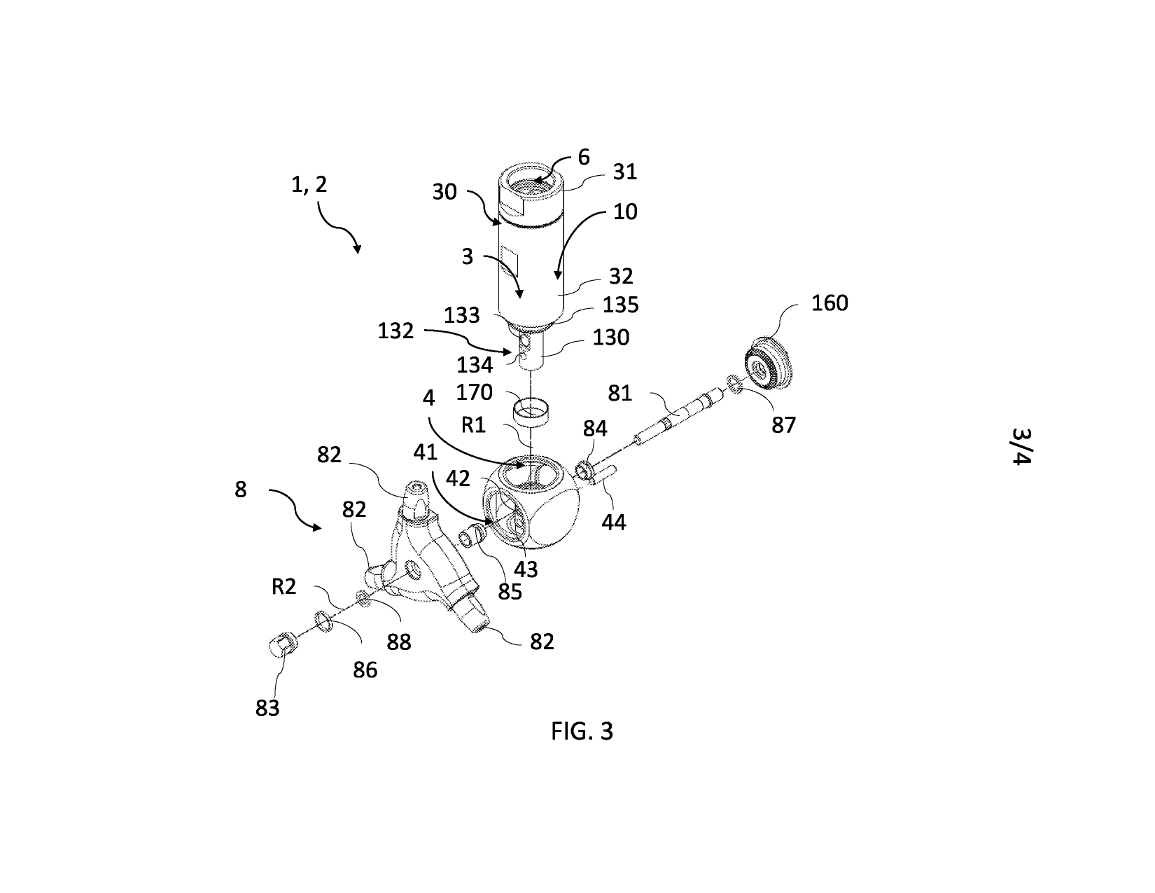

FIG. 2 and FIG. 3 show the tank cleaner 1 according to FIG. 1a and FIG. 1b in two different perspectives. The tank cleaner 1 comprises several key components, each of which is integral to its operation.

The static body 3 is configured for coupling with the supply line 6 to receive a cleaning fluid. The static body 3 houses the gear assembly 10 which includes the main input shaft 120 and the main output shaft 130 as described above. The main output shaft 130 extends in the direction of the main axis of rotation R1 and is designed to drive the rotating body 4 around this main axis of rotation R1.

The gear assembly 10 is at least partly arranged in the static body 3 and includes the gear body 160 that is mounted to the rotating body 4. The gear body 160 is in engagement with the main output shaft 130 and converts the torque of the main output shaft 130 into a rotation of the sub output shaft 81 as described with regard to FIG. 1a and FIG. 1b. The sub output shaft 81 is supported on the rotating body 4 by direct engagement with the nozzle carrier 8 and the gear body 160 and thus extends all the way through the nozzle carrier 8 and the rotating body 4.

The gear carrier 8 has a fastener 83 configured to engage a first distal end 81a of the sub output shaft 81 to fasten the sub output shaft 81 in the mounted state shown in FIG. 1b. The gear body 160 is in engagement with a second distal end 81b of the sub output shaft 81. The sub output shaft 81 is preferably further supported by a first sub output shaft bearing 84 and by a second sub output shaft bearing 85 both associated to the rotating body 4, in particular to the support structure 41. Further, a third sub output shaft bearing 86 may be associated to the fastener 83 to support the sub output shaft 81 in its position in which it extends through the nozzle carrier 8 and the rotating body 4. A first O-ring 86 on the first distal end 81a and a second O-ring 87 on the second distal end 81b may be provided to seal the through the nozzle carrier 8 and the rotating body 4 from the environment thereby ensuring safe and reliable operation of the tank cleaner 1.

The gear body 160 is mounted to the rotating body 4 and is in engagement with the main output shaft 130. The gear assembly 10 has a fixed gear 135 mounted to the main output shaft 130. The gear body 160 has a bevel gear 161 engaging the mating fixed gear 135 for converting the torque of the main output shaft 130 into a rotation of the sub output shaft 81.

The rotating body 4 includes a support structure 41 that holds the main output shaft 130 in a locking position PL (see FIG. 1b). The main output shaft 130 is form-fit locked in this position by a locking element 44.

The nozzle carrier 8 is mounted to the rotating body 4 and is capable of rotating about the sub-axis of rotation R2, which is different from the main axis of rotation R1. The nozzle carrier 8 is equipped with at least one nozzle 82 and includes the sub output shaft 81 that extends in the direction of the sub-axis of rotation R2 and is driven by the main output shaft 130 as described above.

The nozzle carrier 8 further comprises a support structure 41 with at least one guide passageway opening 42 configured to guide the sub output shaft 81 through it. The support structure 41 further has a locking passageway opening 43 that is aligned in parallel and arranged at a distance in the direction of the main rotation axis R1 with regard to the guide passageway opening 42. Both extend in the direction of the sub-axis of rotation R2.

The distal end 132 of the main output shaft 130 that extends beyond the sub output shaft 81 and includes a guide recess 133 and a locking recess 134. The guide recess 133 corresponds to the guide passageway opening 42 and is configured to guide the sub output shaft 81 through it. The locking passageway opening 43 is configured to receive the locking element 44 in the locking position PL (see FIG. 1b). The guide recess 133 corresponds to a guide passageway opening 42 in the support structure 41, which is configured to guide the sub output shaft 81 through it. Similarly, the locking recess 134 corresponds to a locking passageway opening 43 in the support structure 41, which is configured to receive the locking element in the locking position PL (see FIG. 1b).

The nozzle carrier 8 also includes additional components such as a fastening element 170 configured to fasten the locking element 44 in the locking position PL (see FIG. 1b).

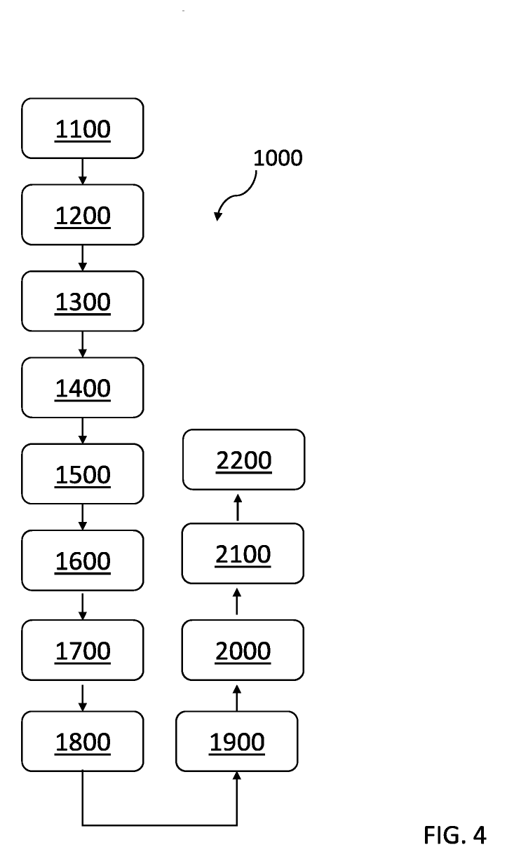

FIG. 4 illustrates a method 1000 for mounting a tank cleaner, in particular a tank cleaner according to FIG. 1a to FIG. 3. In a first step 1100, the method comprises coupling a static body 3 with a supply line 6 for receiving a cleaning fluid, followed by mounting a rotating body 4 on the static body 3 rotary about a main axis of rotation R1 in a second step 1200.

In a third step 1300, the method 1000 comprises mounting a nozzle carrier 8 rotary about a sub-axis of rotation R2 to the rotating body 4, wherein the nozzle carrier 8 has a sub output shaft 81 extending through the rotating body 4 in the direction of the sub-axis of rotation R2.

Finally, in a fourth step 1400, the method 1000 includes arranging 1400 a gear assembly 10 such that a main output shaft 130 of the gear assembly 10 extends in the direction of the main axis of rotation R1 from the static body 3 into the rotating body 4 for driving the rotating body 4 around the main axis of rotation R1, wherein the main output shaft 130 has a distal end 132 extending along the main axis of rotation R1 within the rotating body 4 beyond the sub output shaft 81.

Moreover, the method includes preferred steps 1500 to 2200 which can be executed additionally or alternatively. Also the order in which the steps are described is not limiting but shall be understood as exemplary. In detail:

In a fifth step 1500, the method 1000 comprises bringing the main output shaft 130, in particular the distal end 132 of the main output shaft 130, in form-fit engagement with the rotating body 4.

A sixth step 1600 of the method 1000 includes bringing 1600 the main output shaft 130 in engagement, in particular in form-fit engagement with the sub output shaft 81.

A seventh step 1700 of the method 1000 further includes holding the main output shaft 130 in a locking position PL by a support structure 41 of the rotating body 4 and locking the main output shaft 130 form-fitting in the locking position PL by a locking element 44.

In an eighth step 1800, the method 1000 comprises guiding the sub output shaft 81 through at least one guide passageway opening 42 of the support structure 41 followed by guiding the sub output shaft 81 through a guide recess 133 corresponding to the guide passageway opening 42 of the main output shaft 130 in a ninth step 1900.

A tenth step 2000 of the method 1000 further includes guiding the sub output shaft 81 through at least one locking passageway opening 43 of the support structure 41 and an eleventh step 2100 comprises guiding the sub output shaft 81 through a locking recess 134 corresponding to the locking passageway opening 43 of the main output shaft 130.

Finally, the method 1000 comprises in a twelfth step 2200 fastening the locking element 44 in the locking position PL by a fastening element 170.

1. A tank cleaner for cleaning a tank, the tank cleaner comprising:
a static body configured for coupling with a supply line for receiving a cleaning fluid;
a rotating body mounted on the static body and rotatable about a main axis of rotation;
a gear assembly at least partially arranged in the static body, the gear assembly having a main input shaft and a main output shaft extending along the main axis of rotation and being configured to drive the rotating body about the main axis of rotation; and
a nozzle carrier mounted to the rotating body and rotatable about a sub-axis of rotation, the nozzle carrier having a sub output shaft extending along the sub-axis of rotation and being driven by the main output shaft, and at least one nozzle for dispensing the cleaning fluid, the sub-axis of rotation being different from the main axis of rotation;
wherein the main output shaft has a distal end extending beyond the sub output shaft along the main axis of rotation.

2. The tank cleaner according to claim 1, wherein the main output shaft is in form-fit engagement with the rotating body to allow transmission of rotational motion from the gear assembly to the rotating body.

3. The tank cleaner according to claim 2, wherein the distal end of the main output shaft is in form-fit engagement with the rotating body.

4. The tank cleaner according to claim 1, wherein the main output shaft is in engagement with the sub output shaft.

5. The tank cleaner according to claim 4, wherein the main output shaft is in form-fit engagement with the sub output shaft.

6. The tank cleaner according to claim 1, wherein the sub output shaft is in engagement with the nozzle carrier and a gear body of the gear assembly, and wherein the gear body is mounted to the rotating body and in engagement with the main output shaft for converting the torque of the main output shaft into a rotation of the sub output shaft.

7. The tank cleaner according to claim 6, wherein the sub output shaft is supported on the rotating body by direct engagement with the nozzle carrier and the gear body.

8. The tank cleaner according to claim 1, wherein the rotating body has a support structure for holding the main output shaft in a locking position, and the main output shaft is form-fit locked in the locking position by a locking element.

9. The tank cleaner according to claim 8, wherein the sub output shaft extends through the support structure.

10. The tank cleaner according to claim 9, wherein the support structure has at least one guide passageway opening configured to guide the sub output shaft there through.

11. The tank cleaner according to claim 10, wherein the main output shaft has a guide recess corresponding to the guide passageway opening, the guide recess being configured to guide the sub output shaft through the guide passageway opening.

12. The tank cleaner according to claim 11, wherein the support structure includes at least one locking passageway opening configured to receive the locking element in the locking position.

13. The tank cleaner according to claim 12, wherein the main output shaft includes a locking recess, the locking recess corresponding to the locking passageway opening and configured to receive the locking element in the locking position.

14. The tank cleaner according to claim 8, further comprising a fastening element configured to secure the locking element in the locking position.

15. The tank cleaner according to claim 11, wherein the main output shaft is aligned by the locking element in the locking position such that the sub output shaft of the nozzle carrier may pass through the guide passageway opening.

16. The tank cleaner according to claim 11, wherein the guide passageway opening and the locking passageway opening are aligned in parallel and arranged at a distance along the main axis of rotation.

17. The tank cleaner according to claim 13, wherein at least one of the locking recess and the guide recess is provided at the distal end of the main output shaft.

18. A gear assembly for a tank cleaner, the gear assembly comprising:
a main input shaft; and
a main output shaft extending along a main axis of rotation and configured to drive a rotating body about the main axis of rotation, the main output shaft being configured to drive a sub output shaft extending along a sub-axis of rotation, the sub-axis of rotation being different from the main axis of rotation;
wherein either the main output shaft has a distal end extending beyond the sub output shaft along the main axis of rotation, or the main output shaft is in form-fit engagement with the rotating body to allow transmission of rotational motion from the gear assembly to the rotating body.

19. A method for mounting a tank cleaner, the method comprising the steps:
coupling a static body with a supply line for receiving a cleaning fluid;
mounting a rotating body on the static body to rotate about a main axis of rotation;
mounting a nozzle carrier to the rotating body such that the nozzle carrier is rotatable about a sub-axis of rotation, wherein the nozzle carrier has a sub output shaft extending through the rotating body along the sub-axis of rotation; and
arranging a gear assembly in the static body such that a main output shaft of the gear assembly extends along the main axis of rotation from the static body into the rotating body for driving the rotating body about the main axis of rotation, the main output shaft having a distal end;
wherein either the distal end extends along the main axis of rotation within the rotating body beyond the sub output shaft, or the main output shaft is in form-fit engagement with the rotating body to allow transmission of rotational motion from the gear assembly to the rotating body.

20. A method according to claim 19, further comprising at least one of the following steps:
bringing the distal end of the main output shaft in form-fit engagement with the rotating body;
bringing the main output shaft in form-fit engagement with the sub output shaft;
holding the main output shaft in a locking position by a support structure of the rotating body and locking the main output shaft form-fitting in the locking position by a locking element;
guiding the sub output shaft through at least one guide passageway opening of the support structure;
guiding the sub output shaft through a guide recess corresponding to the guide passageway opening of the main output shaft;
guiding the sub output shaft through at least one locking passageway opening of the support structure;
guiding the sub output shaft through a locking recess corresponding to the locking passageway opening of the main output shaft; and
fastening the locking element in the locking position by a fastening element.
